(19) United States
(12) Patent Application Publication
(10) Pub. No.: US 2007/0027957 A1
(43) Pub. Date: Feb. 1, 2007

(54) Identical recordings on p2p network mapped onto single query result

(75) Inventors: Marc Andre Peters, Eindhoven (NL); Wilhelmus Henrica Gerarda Maria Van Den Boomen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/554,227

(22) PCT Filed: Apr. 28, 2004
(86) PCT No.: PCT/IB04/50537

§ 371 Date: Oct. 25, 2005

(30) Foreign Application Priority Data
Apr. 29, 2003 (EP) 03101183.6

(51) Int. Cl. G06F 15/16

(52) U.S. Cl. 709/217

(57) ABSTRACT

A P2P network of digital recorders is queried about the presence of particular content that relates to a recorded broadcast program. The list of matching query results may be enormous if the program is a popular one. Therefore, the list is condensed by means of representing multiple identical ones among the results as a single item.

### FIELD OF THE INVENTION

The invention relates to an apparatus and to software for sharing recorded broadcasts via a peer-to-peer (P2P) network.

### BACKGROUND ART

The term P2P refers to a type of transient Internet network that allows a group of users with the same networking program to connect with each other and directly access files from one another's data storage. Distributed storage of content information on a (peer-to-peer) P2P network is discussed in, e.g., U.S. Patent Application Publication No. US20020162109 (attorney docket U.S. 018052) filed Apr. 26, 2001, for Eugene Shteyn and herein incorporated by reference. This patent document relates to an electronic content delivery system on a network of end-user devices around a hub. Each end-user device, e.g., a settop box (STB) has storage capability. Under control of the content provider, content is stored in a distributed fashion on the network of these end-user devices for being made available to individual ones of these devices in a P2P fashion so as to cut download time and reduce transmission errors.

Various P2P configurations exist, such as a centralized configuration, a decentralized configuration and a controlled centralized configuration. In a centralized configuration, the system depends on a central server that directs the communication between peers. “Napster” is an example of a centralized configuration. A decentralized configuration has not got a central server, and each peer is capable of acting as a client, as a server or as both. A user connects to the decentralized network by connecting to another user who is connected. “Gnutella” and “Kazaa” are examples of decentralized networks. In a controlled decentralized configuration a user may act as a client, as a server or as both as in the decentralized configuration, but specific operators control which user is allowed to access which particular server. “Morpheus” is an example of the latter. For a brief discussion of P2P network architectures see, e.g., “Stretching The Fabric Of The Net: Examining the present and potential of peer-to-peer technologies”, Software & Information Industry Association (SIIA), 2001.

“Kazaa”, mentioned above, enables the sharing of files. “Kazaa Media Desktop” (KMD) software installed at an end-user enables to connect to other KMD users. The software provides a search functionality to search for particular content shared by other KMD users. The searches are run via specific KMD users, referred to as Supernodes, who have fast connections and powerful computers. A Supernode indexes the content available at users connected to it. Upon locating the desired file, KMD enables to directly download the file from the user who has it. In order to enable to identify content within KaZaa, each file is provided with a meta-tag that represents the fingerprint of the file content. Files with identical content have an identical Message Digest value calculated using cryptographic secure MD5 hashing of the content, see, e.g., “KaZaA P2P FastTrack File Formats” at <http://kzfti.cjb.net> or at <http://home.hetnet.nl/˜frejon55/ft/KazaaFileFormats.html>.

“Morpheus”, mentioned above, uses metadata with XML format descriptors that specify the content of the relevant file. Accordingly, files can be searched by attributes such as title, artist, category, etc. Descriptors are derived automatically from the file's metadata, or are provided by the user via the application's file import wizard.

### SUMMARY OF THE INVENTION

The inventors have realized that using a content hash as identifier has drawbacks when the content relates to a recording of, e.g., a broadcast, that is made available to other users on a P2P network. For example, different recorders may have recorded the same broadcast program, but one recorder started recording a few seconds earlier than the other and, e.g., recorded the announcement as well that preceded the program itself. In another example, to fit a program within the available time slot at a first broadcast station, not all frames are broadcast (without the viewer noticing this), whereas a second station broadcasts the same program with all frames. In both examples, the semantically identical programs get different hash values and therefore get different identities. As a result, an inventory of recorded content based on hash values is not practical, as a search returns multiple hits that are basically identical programs. If the content comprises a recorded broadcast program that was highly popular, the number of hits returned can be very high, which clutters the graphical user-interface (GUI) rendered on a display monitor and confuses the end-user. Similarly, searching files based on user-provided descriptors is not ideal either. In addition, the descriptors for the same content may not be identical as a result of language, typographical errors or mere subjectivity.

The inventors have therefore realized that, especially with regard to recorded broadcast content shared on a P2P network, the user interface is to be made more user-friendly and more ergonomic.

To this end, the inventors propose to cluster the returned hits so as to represent to the user multiple identical ones among a plurality of hits as a single item. More specifically, an embodiment of the invention relates to a consumer electronics (CE) apparatus that has a network connection for a P2P network of recorders. The apparatus has an operational mode for querying the network about specific content recorded from a broadcast. The apparatus presents multiple identical ones among a plurality of query results as a single item. The query itself is accomplished using any appropriate method, including conventional ones as used on the known P2P networks. The query analyzes the metadata of the recorded content available at the peers and returns the results. The metadata comprises data descriptive of the content, e.g., a title,. the cast in case of a movie or play, etc. The input entered to start the query is used to find matching information in the metadata. The metadata of a content file further comprises an identifier of the content. Discriminating between different pieces of content matching the query criterion is based on each different one of the plurality of query results being characterized by a respective identifier. The unique identifier is comprised in the metadata recorded with the content as available on the P2P network. If there are multiple hits among the query results that have the same content identifier, the apparatus lists these multiple hits as a single item.

Preferably, the CE apparatus comprises a digital recorder for recording broadcast content, and has a further operational mode for downloading the specific content found through querying the peers on the P2P network, at least partly from one of the peers. Other parts of the specific content may be downloaded from other peers, e.g., in order to balance network load or recorder load.

The identifier, used to cluster identical query results, comprises, e.g., a V-ISAN (Versioned-International Standard Audiovisual Number). The V-ISAN format builds on ISO's original concept of the ISAN (International Standard Audiovisual Number). The V-ISAN is to uniquely identify audio-visual works. The V-ISAN allows comparisons between V-ISANs to determine whether two pieces of content differ only by being a different version of the same root work or are different episodes of the same series. Another example of a content identifier is the CRID (Content Reference ID) used in the TV-Anytime concept. As explained further below, the CRID is an identifier assigned by an authority to a specific piece of content. CRIDs comply with a hierarchical format that enables to represent relationships between pieces of content as is explained further below. For more information on TV-Anytime and CRIDs see, e.g., Document SP002v1.2 “Specification Series: S-2 on: System Description (Informative with mandatory Appendix B)”, Apr. 5, 2002; and U.S. Patent Application Publication No. US 20020038352 (attorney docket GB 000132) HANDLING BROADCAST DATA TOKENS filed for Alexis Ashley.

Another embodiment of the invention relates to software for being installed on a networked-enabled CE apparatus for enabling to query a P2P network of digital recorders. The software renders the apparatus operational for querying the network about specific content recorded from a broadcast and for presenting multiple identical ones among a plurality of query results as a single item in an appropriate user interface, e.g., on a display monitor.

### BRIEF DESCRIPTION OF THE DRAWINGS

The invention is explained in further detail, by way of example and with reference to the accompanying drawing wherein:

FIG. 1 is a diagram illustrating process steps the invention; and

FIG. 2 is a block diagram of a system in the invention.

Throughout the figures, same reference numerals indicate similar or corresponding features.

### DETAILED EMBODIMENTS

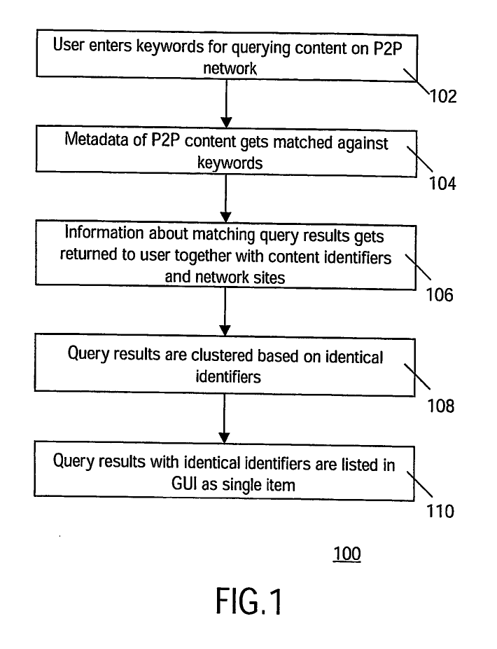

In a P2P network of DVRs, the users can search for content and share recorded content with each other via this network. Peers (users) can create a community and publish content within that group for the purpose of sharing. Broadcasters, or other third parties, e.g., content providers, can create communities as well. When searching for a particular piece, or type, of content, many of the search results may be identical, e.g., as a consequence of the same content having been recorded from the same broadcast at multiple users. A user conducting a search is primarily interested in semantically different results, i.e., in different pieces of content that match the same search criteria) instead of in a list containing many, e.g., thousands, of entries of the same pieces of content. The invention seeks to solve this problem as illustrated in FIG. 1.

FIG. 1 is a diagram that illustrates the steps in a process 100 according to the invention. In step 102 the user enters, through some suitable interface, keywords for querying content on P2P network. In step 104 the metadata of the content available from peers on the P2P network get matched against the keywords entered. The interface through which the user is to specify his/her query criterion is preferably preformatted so as to take the format and segmentation of the metadata into account. For example, the metadata comprises a field “title of the piece of content”. The user interface then preferably has an entry “title” wherein the user can specify keywords that he/she expects to occur in the title of the piece of content sought for. In step 106, information about the matching query results gets returned to the user. This information comprises content identifier and network address for each match. In step 108, the query results that have got the same identical identifier get clustered. In step 110, the user is presented a list of the query results in such a manner that the clustered results are represented as a single item.

An example of an identifier that can be used for clustering identical query results is the TV-Anytime CRID, as mentioned above. The TV-Anytime forum aims to specify a set of industry-wide standards for Digital Video Recorders (DVRs), also referred to as Personal Video Recorders (PVRs). A PVR is a video recorder with a hard disk for video storage. Phase One of TV-Anytime enables audio and video search, capture and playback of content. It also enables segmentation and indexing of that content. Phase Two will specify open standards that build on the foundations of Phase One specifications and will include areas such as targeting, redistribution and new content types. Content redistribution includes moving content around among devices and systems. Examples of redistribution are, e.g., content sharing, home networking and removable media. Content sharing is the P2P distribution of content over provider networks. Home networking relates to the sharing of content among multiple storage devices and display terminals within a defmed private physical network. Removable media are involved in the redistribution of content on physical storage such as optical discs, flash cards, etc.

One feature of the TV-Anytime specifications is content referencing. This specification provides the ability to map a unique identifier of a piece of content such as a TV program on a time and/or location (e.g., TV channel) where this piece of content can be acquired. The identifier is called a CRID (“content reference ID”). In the terminology of TV-Anytime, an organization that creates CRIDs is called an “authority”. There can be any number of authorities producing CRIDs, but each authority is uniquely identified by a name. The TV-Anytime standard uses the DNS name registration system to ensure that these names are unique. Each CRID has the name of the authority that issued it embedded in the CRID, and there is accordingly a requirement for a means to take an authority name from a CRID, and find the server on the Internet where the CRID can be converted to a location.

In an embodiment of the invention the TV-Anytime CRIDs are being used to eliminate duplicates. Content that originates from the same content creator (authority) will have the same CRID. The user will be presented only the different results from the responses to his/her query. The results that are identical are grouped together and presented to the user as a single result in a GUI. This way, the user only sees the semantically different results to his/her search request. If a user records a piece of content, this CRID will be attached to it, so all recorders that record that piece will have the same CRID attached to it. Now, if the user is interested in one of the results of his/her query, the recorder can either choose one from among the identical results, or present the user with a list of sources from which the content is available. The latter can give the user the option to decide between the sources based on, for example, how much it costs to download the content (in a pay per view model), if this is applicable. Alternatively, the user's system determines automatically from which resource or resources to download the content in order to, e.g., optimize bandwidth usage, network load, data traffic, etc.

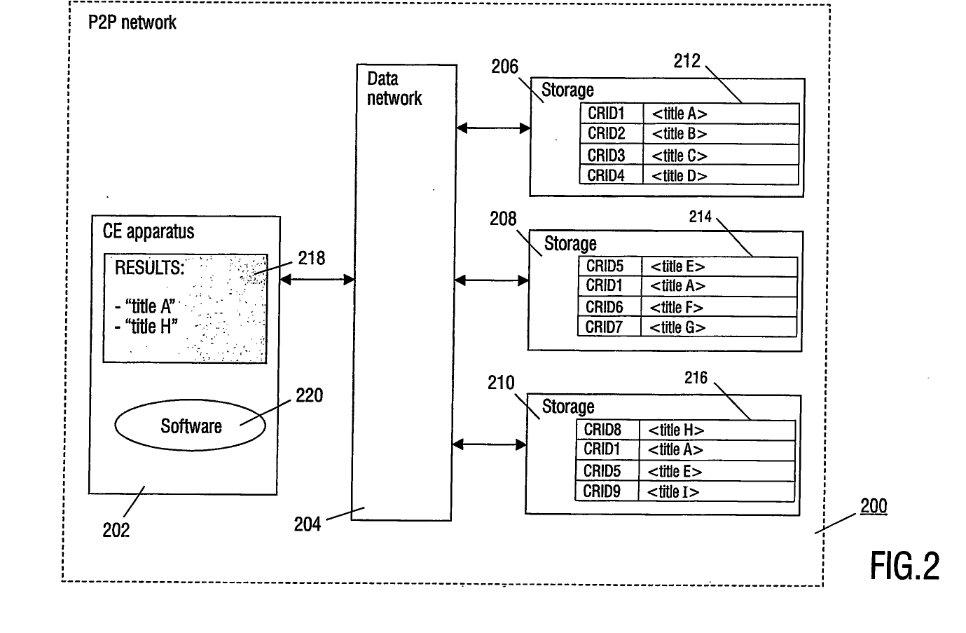

FIG. 2 is a block diagram of a P2P system 200 in the invention. System 200 comprises a CE apparatus 202, a data network 204, and a plurality of data storage devices 206, 208, . . . , and 210. Network 204 connects apparatus 202 to each of storage devices 206-210. In this example, each of devices 206-210 comprises a respective DVR for recording content that is being broadcast or otherwise made available to the user of the respective DVR. CE apparatus 202 has a first operational mode wherein it is enabled to query program inventories 212, 214, . . . , and 216 of devices 206-210, respectively. Inventories 212-216 are automatically established based on, e.g., the metadata recorded with the programs, or based on the EPG, used to program recorders 206-210. Inventories 212-216 include content identifiers, here the CRIDs, and further descriptive information such as the titles.

Assume that the user queries P2P network 200 about content that has a certain keyword in its title as represented in its metadata. Assume now that the matching query results refer to “title A” in inventories 212, 214 and 216, and to title H in inventory 216. The user would be presented with four hits in a conventional approach. In the invention, CE apparatus 202 also takes the CRIDs into account in order to present normalized results to the user. Three hits all have the same identifier “CRID1”. The user of apparatus 202 now sees in a GUI 218 of apparatus 202 only two results: “title A” and “title H”. If the user wishes to download the content associated with title A, he/she clicks on “title A” in GUI 218. Apparatus 202 now can proceed to select any method of downloading the associated content. For example, apparatus chooses to download from device 206 because it is fewer network hops away than apparatus 208 and 210. All this is transparent to the user of apparatus 202.

In an embodiment of the invention, the functionality of apparatus 202 relating to the querying and to the condensed representation of the query results is implemented by means of software 220 installed on, e.g., a PC, an STB, or an interactive TV, etc. For example, this software 220 comes on top of conventional P2P equipment used for sharing files. As noted above, if the files relate to recorded broadcasts of popular programs, the presentation of query results may lead to huge lists. The software in the invention enables to condense the list of query results to a manageable length by means of mapping identical results relating to different locations (peers) onto a single entry in the list.

1. A CE apparatus having a network connection for a P2P network, and having an operational mode for querying the network about specific content recorded from a broadcast and for presenting multiple identical ones among a plurality of query results as a single item.

2. The CE apparatus of claim 1, wherein each different one of the plurality of query results is characterized by a respective identifier comprised in recorded metadata.

3. The CE apparatus of claim 2, wherein the respective unique identifier comprises a respective CRID.

4. The CE apparatus of claim 1, comprising a digital recorder for recording broadcast content.

5. The CE apparatus of claim 1, having a further operational mode for downloading the specific content from the P2P network.

6. Software for being installed on a networked-enabled CE apparatus for enabling to participate in a P2P network, the software rendering the apparatus operational for querying the network about specific content recorded from a broadcast and for presenting multiple identical ones among a plurality of query results as a single item.

7. The software of claim 6, operative to differentiate among the query results based on content identifiers in metadata.

8. The software of claim 7, wherein the content identifiers are based on CRIDs.

9. The CE apparatus of claim 1, wherein for the single item the multiple identical ones among the plurality of query results are counted.

10. A method for use on a Peer-to-Peer network, the method comprising enabling to query the network about specific content recorded from a broadcast and to present multiple identical ones among a plurality of query results as a single item.

11. The method of claim 10, wherein each different one of the plurality of query results is characterized by a respective identifier comprised in recorded metadata.

12. The method of claim 11, wherein the respective unique identifier comprises a respective CRID.

13. The method of claim 10, comprising counting, for the single item, the multiple identical ones among the plurality of query results.
